(19) United States
(12) Patent Application Publication
(10) Pub. No.: US 2022/0033734 A1
(43) Pub. Date: Feb. 3, 2022

(54) FABRIC CONDITIONER COMPOSITIONS

(71) Applicant: Conopco, Inc., d/b/a UNILEVER, Englewood Cliffs, NJ (US)

(72) Inventors: Nigel Peter BIRD, Merseyside (GB); Thomas Richard POINTON, Merseyside (GB)

(21) Appl. No.: 17/290,636

(22) PCT Filed: Nov. 7, 2019
(86) PCT No.: PCT/EP2019/080622

§ 371 Date: Apr. 30, 2021

(30) Foreign Application Priority Data
Nov. 14, 2018 (EP) 18206296.8

(51) Int. Cl. C11D 3/00; C11D 3/50; C11D 3/20; C11D 3/34; C11D 11/00

(52) U.S. Cl. CPC C11D 3/001; C11D 3/505; C11D 11/0017; C11D 3/349; C11D 3/2082

(57) ABSTRACT

A fabric conditioner composition comprising: a. fabric softening active; b. a short chain (C1 to C6), unsaturated, organic acid or salt thereof having at least two carboxyl groups; and c. perfume composition.

### FIELD OF THE INVENTION

The present invention relates to preservation for fabric conditioner compositions.

### BACKGROUND OF THE INVENTION

There remains a need for improved preserved fabric conditioner compositions. The preservation needs to be stable in the fabric conditioner compositions and effective against the pathogens typically found in such compositions as a consequence of manufacturing processes.

The present application has found a preservation system suitable for use with fabric conditioner compositions. The preservation system is readily available, cost effective and easy to formulate with compositions of the invention.

### SUMMARY OF THE INVENTION

In one aspect of the present invention is provided a fabric conditioner composition comprising:
a. fabric softening active;
b. a short chain (C1 to C6), unsaturated, organic acid or salt thereof having at least two carboxyl groups; and
c. perfume composition.

In an alternative aspect of the present invention is provided a method of preserving a fabric conditioner composition by incorporating an organic acid having at least two carboxyl groups or salt thereof.

In a further aspect of the present invention is provided the use of an organic acid having at least two carboxyl groups or salt thereof to preserve a fabric conditioner formulation.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Preservation

The compositions of the present invention comprise a short chain (C1 to C6), unsaturated, organic acid or salt thereof. Preferably the organic acid comprises two carboxyl groups. Preferably the unsaturation occurs on a side chain. Most preferably the organic acid is itaconic acid or salt thereof. Preferably the total level of short chain (C1 to C6), unsaturated, organic acid or salt thereof in particular itaconic acid in the total composition is from 0.005 to 7 w.t. % % of the total composition, more preferably 0.01 to 5 w.t. % more preferably from 0.05 to 2 w.t. %, most preferably from 0.1 to 2 w.t. %.

The organic acid having at least two carboxyl groups or salt thereof, as described herein, can be used to preserve a fabric conditioner formulation.

### Fabric Softening Active

The composition of the present invention is a fabric conditioner or fabric softener. Fabric conditioners comprise active materials which soften or condition fabric. These are fabric softening compounds. The fabric softening compounds (also referred to herein as a fabric softening or conditioning actives or agents) may be any material known to soften fabrics. These may be polymeric materials or compounds known to soften materials.

Examples of suitable fabric softening actives include: quaternary ammonium compounds, silicone polymers, polysaccharides, clays, amines, fatty esters, dispersible polyolefins, polymer latexes and mixtures thereof.

The fabric softening compounds may preferably be cationic or non-ionic. Preferably, the fabric softening compounds of the present invention are cationic. Suitable cationic fabric softening compounds are described below.

Fabric conditioning compositions for use in accordance with the invention may be dilute or concentrated. Dilute products typically contain up to about 6%, generally about 1 to 5% by weight of softening compounds, whereas concentrated products may contain up to about 50 wt %, preferably from about 5 to about 50%, more preferably from 6 to 25% by weight active. Overall, the products of the invention may contain from 1 to 50 wt %, preferably from 2 to 25 wt % of softening compounds, more preferably 2 to 20 wt % of softening compounds.

The preferred softening compounds for use in fabric conditioner compositions of the invention are quaternary ammonium compounds (QAC).

The QAC preferably comprises at least one chain derived from fatty acids, more preferably at least two chains derived from a fatty acids. Generally fatty acids are defined as aliphatic monocarboxylic acids having a chain of 4 to 28 carbons. Preferably the fatty acid chains are palm or tallow fatty acids. Preferably the fatty acid chains of the QAC comprise from 10 to 50 wt % of saturated C18 chains and from 5 to 40 wt % of monounsaturated C18 chains by weight of total fatty acid chains. In a further preferred embodiment, the fatty acid chains of the QAC comprise from 20 to 40 wt %, preferably from 25 to 35 wt % of saturated C18 chains and from 10 to 35 wt %, preferably from 15 to 30 wt % of monounsaturated C18 chains, by weight of total fatty acid chains.

The preferred quaternary ammonium fabric softening compounds for use in compositions of the present invention are so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt % of the fabric softening compound, preferably no more than 60 wt % e.g. no more than 55%, or even no more that 45% of the fabric softening compound and at least 10 wt % of the monoester linked component.

A first group of quaternary ammonium compounds (QACs) suitable for use in the present invention is represented by formula (I):

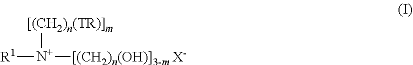

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

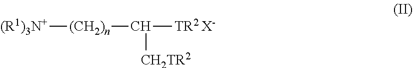

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the fourth group of QACs is represented the by the formula:

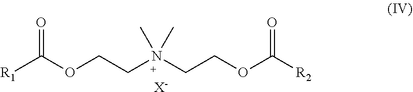

A fourth group of QACs suitable for use in the invention are represented by formula (V)

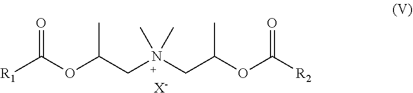

R1 and R2 are independently selected from 010 to C22 alkyl or alkenyl groups, preferably C14 to C20 alkyl or alkenyl groups. X— is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quarternary ammonium materials present in the composition, the iodine value, referred to above, represents the mean iodine value of the parent fatty acyl compounds or fatty acids of all of the quarternary ammonium materials present. Likewise, if there is any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (VI):

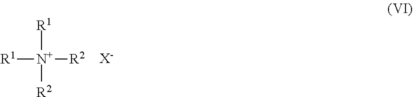

wherein each R1 group is independently selected from C1 to C4 alkyl, hydroxyalkyl or C2 to C4 alkenyl groups; R2 group is independently selected from C8 to C28 alkyl or alkenyl groups, and X— is as defined above.

### Perfume

The compositions of the present invention preferably comprise 0.01 to 30 w.t. % perfume materials, i.e. free perfume and/or perfume microcapsules. As is known in the art, free perfumes and perfume microcapsules provide the consumer with perfume hits at different points during the wash cycle. It is particularly preferred that the compositions of the present invention comprise a combination of both free perfume and perfume microcapsules.

Preferably the compositions of the present invention comprise 0.1 to 10 w.t. % perfume materials, more preferably 0.1 to 5 w.t. % perfume materials, most preferably 0.15 to 3 w.t. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprise 0.05 to 15 w.t. %, more preferably 0.1 to 10 w.t. %, most preferably 0.1 to 5 w.t. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.05 to 15 w.t. %, more preferably 0.1 to 10 w.t. %, even more preferably 0.1 to 5 w.t. % perfume microcapsules and most preferably 0.05 to 4 w.t. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Co-Softeners and Fatty Complexing Agents

Co-softeners may be used. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention may comprise a fatty complexing agent.

Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include tallow fatty acid or vegetable fatty acids, particularly preferred are hardened tallow fatty acid or hardened vegetable fatty acid (available under the trade name Pristerene™, ex Croda). Preferred fatty alcohols include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman).

The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

### Non-Ionic Surfactant

The compositions may further comprise a nonionic surfactant. Typically, these can be included for the purpose of stabilising the compositions. Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula (VII):

R—Y—(C₂H₄O)_{z}—CH₂—CH₂—OH (VII)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above for formula (VII), or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (Clariant) based on coco chain and 20 EO groups is an example of a suitable nonionic surfactant.

If present, the nonionic surfactant is present in an amount from 0.01 to 10%, more preferably 0.1 to 5 by weight, based on the total weight of the composition.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

Suitable surfactants are substantially water soluble surfactants of the general formula (VIII):

R—Y—(C₂H₄O)_{z}—CH₂—CH₂—OH (VIII)

where R is selected from the group consisting of primary, secondary and branched chain alkyl and/or acyl hydrocarbyl groups (when Y=—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g. 14 to 20 carbon atoms.

In the general formula for the ethoxylated nonionic surfactant, Y is typically:

—O—, —C(O)O—, —C(O)N(R)— or —C(O)N(R)R—

in which R has the meaning given above for formula (VIII), or can be hydrogen; and Z is at least about 6, preferably at least about 10 or 11.

Lutensol™ AT25 (BASF) based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell.

### Thickening Polymer

The laundry composition of the present invention may comprise a cationic polymer. This refers to polymers having an overall positive charge. These may be used for structuring the compositions or for delivering benefit agents to a fabric.

The cationic polymer may be naturally derived or synthetic. Examples of suitable cationic polymers include: acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

Polysacchride based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

A preferred polysaccharide polymer is cationic cellulose. This refers to polymers having a cellulose backbone and an overall positive charge.

Cellulose is a polysaccharide with glucose as its monomer, specifically it is a straight chain polymer of D-glucopyranose units linked via beta-1,4 glycosidic bonds and is a linear, non-branched polymer.

The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

A preferred class of cationic cellulose polymers suitable for this invention are those that have a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

Example cationic cellulose polymers are salts of hydroxyethyl cellulose reacted with trimethyl ammonium substituted epoxide, referred to in the field under the International Nomenclature for Cosmetic Ingredients as Polyquaternium 10 and is commercially available from the Amerchol Corporation, a subsidiary of The Dow Chemical Company, marketed as the Polymer LR, JR, and KG series of polymers. Other suitable types of cationic celluloses include the polymeric quaternary ammonium salts of hydroxyethyl cellulose reacted with lauryl dimethyl ammonium-substituted epoxide referred to in the field under the International Nomenclature for Cosmetic Ingredients as Polyquaternium 24. These materials are available from Amerchol Corporation marketed as Polymer LM-200.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is a quaternised hydroxy ether cellulose cationic polymer. These are commonly known as polyquaternium-10. Suitable commercial cationic cellulosic polymer products for use according to the present invention are marketed by the Amerchol Corporation under the trade name UCARE.

The counterion of the cationic polymer is freely chosen from the halides: chloride, bromide, and iodide; or from hydroxide, phosphate, sulphate, hydrosulphate, ethyl sulphate, methyl sulphate, formate, and acetate.

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consist of only one type of structural unit, i.e., the polymer is a homopolymer. The cationic polymer may consist of two types of structural units, i.e., the polymer is a copolymer. The cationic polymer may consist of three types of structural units, i.e., the polymer is a terpolymer. The cationic polymer may comprise two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, vinylimine, vinyl imidazole, quaternized vinyl imidazole, diallyl dialkyl ammonium salts, and mixtures thereof. Preferably, the cationic monomer is selected from: diallyl dimethyl ammonium salts (DADMAS), N, N-dimethyl aminoethyl acrylate, N,N-dimethyl aminoethyl methacrylate (DMAM), [2-(methacryloylamino)ethyl]trl-methylammonium salts, N, N-dimethylaminopropyl acrylamide (DMAPA), N, N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and mixtures thereof. The cationic polymer may comprise a anionic structural units derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

Some cationic polymers disclosed herein will require stabilisers i.e. materials which will exhibit a yield stress in the ancillary laundry composition of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic acrylate polymer.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

Compositions according to the current invention preferably comprise cationic polymer at a level of 0.001 to 5 w.t % of the formulation, preferably 0.01 to 3 w.t. % of the formulation, more preferably 0.1 to 2 w.t. % of the formulation.

### Further Optional Ingredients

The compositions may comprise other ingredients of fabric conditioner liquids as will be known to the person skilled in the art. Among such materials there may be mentioned: antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

### Form of the Invention

The fabric conditioner composition is preferably in an aqueous form. The compositions preferably comprise at least 80 w.t. % water.

### Method of Production

In one aspect of the present invention, is the method of manufacturing the fabric conditioners herein described. The organic acid may be dispersed in the aqueous solution either prior to or after the softening active. In a preferred method or manufacture, the organic acid is dispersed in the aqueous solution prior to the addition of the softening active.

### Treatment of Clothes

In one aspect of the present invention, clothes are treated with a fabric conditioner composition. The treatment is preferably during the washing process. This may be hand washing or machine washing. Preferable the fabric conditioner is used in the rinse stage of the washing process.

Preferably the clothes are treated with a 10 to 100 ml dose of fabric conditioner for a 4 to 7 kg load of clothes. More preferably, 10 to 80 ml for a 4 to 7 kg load of clothes.

### Example 1: Example Formulations of the Present Invention

TABLE 1
Example formulations

| | w.t. % of Composition | |
|---|---|---|
| | 3.45 w.t. | 10.5 w.t. |
| Ingredient | % active | % active |
| Di-[partially hardened tallow | 2.96 | 10.5 |
| ester] of triethanolammonium | | |
| methylsulphate | | |
| Cetearyl alcohol | 0.49 | |
| Free perfume oil | 0.27 | 0.87 |
| Melamine formaldehyde perfume | 0 | 0.44 |
| microcapsule | | |
| Organic acid | 0.5-2.5 | 0.5-2.5 |
| 1M Hydrochloric acid | As required to | As required to |
| | adjust pH | adjust pH |
| Water and minors | To 100.000 | To 100.000 |

### Example Method of Production

Heat water to ˜45° C., disperse the Cetearyl alcohol, perfume microcapsules, organic acid and minors. Add a premix of melted quaternary ammonium active. Cool and add free perfume and other minors.

### Example 2: Testing of Preservation Chemicals in Fabric Conditioner Formulations

A fabric conditioner formulation according to Table 1 was prepared:

TABLE 2
Test formulations

w.t. % of Composition

| | 3.45 w.t. | 10.5 w.t. |
|---|---|---|
| Ingredient | % active | % active |
| Di-[partially hardened tallow | 2.960 | 10.50 |
| ester] of triethanolammonium | | |
| methylsulphate | | |
| Cetearyl alcohol | 0.490 | |
| (Stenol 1618L ex. BASF) | | |
| Organic acid in 1M Sodium | As in tables | As in tables |
| hydroxide | 3 & 4 | 3 & 4 |
| 1M Hydrochloric acid | As required to | As required to |
| | adjust pH | adjust pH |
| Water and minors | To 100.000 | To 100.000 |

### Sample Preparation:

Water was heated to ˜45° C., the Cetearyl alcohol was added followed by the minors. A premix of melted quaternary ammonium active was then added and mixed. The formulation was then cooled to ˜35° C. and any remaining minors added.

Itaconic acid, lactic acid and citric acid were purchased from Sigma-Aldrich. Samples of unpreserved fabric conditioner were dosed with itaconic acid, citric acid or lactic acid separately, according to Tables 3 and 4. Each dosed product was adjusted to pH 5 using 50% sodium hydroxide (Sigma-Aldrich). An unpreserved sample was kept as a control.

### Test Method:

A modified challenge test method was performed on samples as defined in Tables 2 and 3. The microbial compositions comprising the bacteria listed in Tables 2 and 3 were produced with an inoculum level of 5×107 CFU/G in sodium chloride.

The microbial compositions were added to each fabric conditioner formulation at a ratio of 1:10 (by weight) microbial composition to fabric conditioner formulation.

Each inoculated product sample was mixed with a sterile spatula to ensure a homogenous distribution of the inocula throughout the product.

Both the inoculum level and the level of microorganism within each sample was quantified using a Total Viable Count (TVC) pour plate method after contact times as indicated in data tables. Dilutions were performed with a subsample separately in Peptone (0.1%)/tween 80 (2%) neutralising agent. A 1:10 and 1:100 dilution of each subsample was performed and pour plates produced at each dilution using tryptone soya agar. Plates were incubated at 28° C. for 48 hours and then examined for growth. Visible colonies were counted with the aid of a Quebec Colony Counter and recorded for analysis against the challenge test criteria.

TABLE 3
Gram-negative non-fermenting bacteria results

| Gram-negative non-fermenting | | | | | | |
|---|---|---|---|---|---|---|
| bacteria: | | | | | | |
| B. cepacia | | | | | | |
| P. aeruginosa | | Recovery (cfu/g) | | | | |
| Strenotrophomonas sp | | 24 hours | 48 hours | 5 days | 7 days | 14 days |
| 0.125% itaconic | 10.5% active | 1.44E+04 | 5.30E+02 | <10 | <10 | <10 |
| acid | | | | | | |
| 0.125% lactic acid | 10.5% active | 3.40E+04 | 5.60E+02 | <10 | <10 | <10 |
| 0.125% itaconic | 3.45% active | 2.08E+04 | 3.00E+01 | <10 | <10 | <10 |
| acid | | | | | | |
| 0.125% lactic acid | 3.45% active | 4.60E+03 | 9.70E+03 | 3.20E+03 | 1.78E+03 | 1.62E+03 |
| 0.375% itaconic | 3.45% active | 3.50E+03 | <10 | <10 | <10 | <10 |
| acid | | | | | | |
| 0.375% lactic acid | 3.45% active | 4.30E+03 | <10 | <10 | <10 | <10 |
| 0.5% itaconic acid | 3.45% active | <10 | <10 | <10 | <10 | <10 |
| 0.5% citric acid | 3.45% active | >10\hat{ }5 | 8.60E+04 | 6.00E+01 | 5.00E+01 | 1.00E+02 |
| 1.0% itaconic acid | 3.45% active | <10 | <10 | <10 | <10 | <10 |
| 1.0% citric acid | 3.45% active | 1.68E+05 | 2.08E+03 | <10 | <10 | <10 |
| Unpreserved | 3.45% active | >10\hat{ }5 | 4.90E+04 | 4.50E+04 | 3.30E+03 | 8.50E+03 |

TABLE 4
Gram-negative fermenting bacteria results

| Gram-negative fermenting bacteria: | | Recovery (cfu/g) | | | |
|---|---|---|---|---|---|
| E. cloacae | | 48 | 5 | 7 | 14 |
| Klebsiella sp. | | hours | days | days | days |
| 0.125% itaconic acid | 10.5% active | <10 | <10 | <10 | <10 |
| 0.125% lactic acid | 10.5% active | 1.00E+02 | <10 | <10 | <10 |
| 0.250% itaconic acid | 10.5% active | <10 | <10 | <10 | <10 |
| 0.250% lactic acid | 10.5% active | 6.00E+01 | <10 | <10 | <10 |
| 0.375% itaconic acid | 10.5% active | <10 | <10 | <10 | <10 |
| 0.375% lactic acid | 10.5% active | 5.00E+01 | <10 | <10 | <10 |

Itaconic acid out performed citric acid, lactic acid and unpreserved systems.

1. An aqueous fabric conditioner composition comprising:
a. fabric softening active;
b. a short chain (C1 to C6), unsaturated, organic acid or salt thereof having at least two carboxyl groups; and
c. perfume composition
wherein the fabric softening active is a quaternary ammonium compound comprising at least two chains derived from fatty acids.

2. A composition according to claim 1, wherein the short chain, unsaturated, organic acid is itaconic acid or salt thereof.

3. A composition according to claim 1, wherein the level of organic acid or salt thereof having at least two carboxyl groups is 0.005 to 7 w.t. % of the fabric conditioner composition.

4. (canceled)

5. (canceled)

6. A composition according to claim 1, wherein the level of fabric softening agent is 2 to 50 w.t. % of the fabric conditioner composition.

7. A composition according to claim 1, wherein the perfume composition comprises free perfume.

8. A composition according to claim 7, wherein the level of free perfume is 0.05 to 15 w.t. % of the fabric conditioner composition.

9. A composition according to claim 1, wherein the perfume composition comprises encapsulated perfume.

10. A composition according to claim 9, wherein the level of encapsulated perfume is 0.05 to 15 w.t. % of the fabric conditioner composition.

11. A method comprising:
preserving an aqueous fabric conditioner composition by incorporating a short chain (C1 to C6), unsaturated, organic acid or salt thereof having at least two carboxyl groups;
wherein the fabric conditioner composition comprises
a. fabric softening active;
b. a short chain (C1 to C6), unsaturated, organic acid or salt thereof having at least two carboxyl groups; and
c. perfume composition;
wherein the fabric softening active is a quaternary ammonium compound comprising at least two chains derived from fatty acids.

12. A method according to claim 11, wherein the short chain, unsaturated, organic acid is itaconic acid or salt thereof.

13. A method according to claim 11, wherein the organic acid having at least two carboxyl groups or salt thereof is dispersed in the aqueous solution prior to the addition of the softening active

14. (canceled)

15. (canceled)
